(19) United States
(12) Patent Application Publication
(10) Pub. No.: US 2008/0090780 A1
(43) Pub. Date: Apr. 17, 2008

(54) Storage stable azadirachtin pesticide formulation

(75) Inventors: Dale R. Sanson, Kearney, MO (US); James A. Armbruster, Kansas City, MO (US)

Correspondence Address: HOVEY WILLIAMS LLP, 10801 Mastin Blvd., Suite 1000, Overland Park, KS, 66210, US

(73) Assignee: PBI/GORDON CORPORATION, Kansas City, MO (US)

(21) Appl. No.: 11/549,451

(22) Filed: Oct. 13, 2006

(51) Int. Cl. A01N 65/00; A01N 37/08; A01N 43/02; A01N 37/34

(52) U.S. Cl. 514/66; 514/450; 514/519; 514/530

(57) ABSTRACT

A storage stable, efficacious pesticide formulation is provided that is dilutable by the user and contains azadirachtin (AZA) and a pyrethrin or pyrethroid (PYR), and optionally an aprotic solvent and non-ionic, substantially water-free emulsifier. A sufficient amount of the PYR is provided to complex with the AZA A on opposite sides of the molecular structure thereof, thereby preventing rearrangement of the AZA A molecule in the presence of moisture that would result in hydrolysis and decomposition of AZA A. The AZA-PYR combination is sufficiently chemically stable such that less than 10% of the AZA A is decomposed when the formulation is subjected to an accelerated aging test for 30 days at 40° C. in a sealed container. The molar ratio of PYR to AZA A is preferably within the range of 0.5/1-10.5/1, more preferably within the range of 1.5/1-7/1, and most preferably with the range of 3/1-6/1. A solvent, when provided, should be in the range of about 70% to about 90% by weight based on the weight of the formulation, and the emulsifier should be within the range of about 0% to about 20%.

### BACKGROUND OF THE INVENTION

1. Field of the Invention

This invention relates to a storage stable, efficacious pesticide formulation dilutable by the user that contains azadirachtin made up of azadirachtin A and azadirachtin B, a pyrethrin or pyrethroid, a solvent, and an emulsifier. The pyrethrin or pyrethroid complexes with and minimizes decomposition of the azadirachtin A. An amount of the pyrethrin or pyrethroid is incorporated to form a complex with the azadirachtin A on opposite sides of the molecular structure thereof. It has been unexpectedly discovered that the greater the degree of isomerization of the pyrethroid when used, the more effective the pyrethroid is in preventing decomposition of azadirachtin A. The amount of the pyrethroid or pyrethrin incorporated in the formulation should be sufficient to prevent decomposition of no more than ten percent of the azadirachtin A when the formulation is subjected to an accelerated aging test for 30 days at 40° C. in a sealed container. Preferably, an aprotic heterocyclic or mono, di-, or polycyclic aromatic solvent is provided having C₂-C₂₅ carbon atoms and that is compatible with the azadirachtin A and pyrethrin or pyrethroid. In addition, a non-ionic emulsifier is preferably included in the formulation.

2. Description of the Prior Art

An escalating problem encountered with insecticidal agents is resistance of the insect hosts to a particular insecticide. Insect control with long-used insecticides is becoming increasingly difficult because certain insects are no longer susceptible to normal levels of an insecticide, necessitating higher and higher concentrations of the toxic agent. This is not only deleterious to the environment, but, in addition, results in higher costs of treatment with less and less effectiveness.

Pyrethrins have been a mainstay of the insecticide industry for many years. Pyrethrins, a natural insecticide derived from members of the chrysanthemum family, have a quick knock-down effect against many insect species. However, pyrethrins are relatively unstable in the atmosphere and, therefore, may not last long enough to kill an adequate proportion of a particular insect population. Pyrethroids are synthetic versions of pyrethrins and generally last days or weeks versus pyrethrin longevity of hours, and thus provide longer-lasting control at an approved label concentration.

Pyrethrins and pyrethroids function in a similar manner by acting on tiny channels through which sodium is pumped to cause excitation of neurons in the insect. The insecticidal agents prevent the sodium channels from closing, thereby resulting in continual nerve impulse transmission, tremors, and eventually death.

Because of the brief longevity of pyrethrins and, to only a slightly greater degree, pyrethroids, much effort has been given and resources committed to formulation of a combination insecticide that has the knock-down properties of the pyrethrins and pyrethroids, yet has a longer effective toxic longevity.

Azadirachtin, which is derived from seeds of the neem tree fruit, is an established and proven insecticidal agent having longer insect control than pyrethrins and pyrethroids because of systemic properties. Azadirachtin interferes with the synthesis of an insect's prothoracicotropic hormone, thus retarding growth and development of an insect. Azadirachtin also acts as a feeding deterrent by interference with phagostimulants, which play a role in the normal feeding behavior of insects and related arthropods. Azadirachtin as recovered from neem tree seeds typically contains about 83% of azadirachtin A and about 17% of azadirachtin B. Although azadirachtin B is relatively stable, the larger proportion of azadirachtin A rapidly decomposes, especially when exposed to protic agents such as water. Hydrolysis and the resulting decomposition of azadirachtin A occurs relatively rapidly and to a significant extent when the insecticide is exposed to the atmosphere and water present in the air.

Efforts to develop a stable azadirachtin formulation have heretofore been largely unsuccessful because of inability to prevent hydrolysis and decomposition of the insecticide. In U.S. Pat. No. 5,001,146, the patentees assert that they discovered the stability of azadirachtin in solution is decreased in the presence of protic solvents, in particular water, acids, and bases. The stability problem was said to be ameliorated by the use of an aprotic solvent having moderately high dielectric constants, which does not contain acidic hydrogen. “Storage stable” was said to refer to formulations that retained at least 80% of their active ingredient content after one year at room temperature (25° C.). An azadirachtin formulation that loses as much as 20% of its active ingredient while in storage is not a commercially viable product.

U.S. Pat. No. 5,352,672 describes what is said to be a synergistic acaricidal combination of neem seed extract and bifenthrin. A ratio of bifenthrin to azadirachtin of from 4,000:1 to 3:10 is asserted in the patent description to demonstrate synergism, but there is no disclosure with respect to stability of the formulations.

A synergistic formulation is said to be obtained in U.S. Pat. No. 5,679,662 by combining azadirachtin at a weight ratio of between 0.02 and 1 part of pyrethrum. Organic solvents may be added as auxiliary solvents and a non-ionic surfactant may be included in the formulation. Again, there is no teaching or suggestion of what proportions of the constituents should be provided to produce a shelf stable pesticide formulation.

In U.S. Pat. No. 5,695,763, there is an assertion that a stable azadirachtin-rich insecticide can be provided by producing a powdery concentrate of the active substance which has a very long storage stability. However, azadirachtin as a powder is not a commercially viable insecticide because of the low concentration as applied and the difficulty of a user accurately incorporating an approved amount of the active ingredient with a suitable carrier. Alternatively, the '763 patent teaches that a surfactant having a higher solubility for azadirachtin than water may be combined with the azadirachtin to produce a concentrate that is usable directly or after dilution with water and that can be stored for several months. This again is not a viable commercial product because of decomposition of the azadirachtin and consequent significant loss of activity would occur when the azadirachtin was combined with a water-based surfactant.

There is also a suggestion in the '763 patent that dried azadirachtin after formulation with at least one emulsifier and a solvent is useful as an insecticide. The specific nature of the solvent and the emulsifier are not disclosed and there is no indication of the proportions of the additives.

An organic solvent-free pesticide formulation containing azadirachtin is described in U.S. Pat. No. 6,811,790. The formulation is said to be storage stable by the inclusion of from about 1% to about 60% by weight of a vegetable oil, from about 20% to about 55% by weight of a non-ionic surfactant, and from about 1% to about 5% by weight of azadirachtin.

### SUMMARY OF THE INVENTION

It has now been discovered that a storage stable, efficacious dilutable pesticide concentrate formulation that exhibits insect knock-down properties, as well as residual and a degree of systemic properties, can be provided by combining a pyrethrin or pyrethroid with azadirachtin. A sufficient quantity of the pyrethrin or pyrethroid is provided with respect to the azadirachtin present to prevent decomposition of the azadirachtin A constituent during storage of the formulation. Desirably, the formulation includes a particular type of solvent and a substantially water-free non-ionic emulsifier.

As used in this description and in the claims, the abbreviation “AZA” is used to designate a commercially available azadirachtin material, preferably in powder form, that includes azadirachtin A (AZA A) and azadirachtin B (AZA B). An exemplary azadirachtin technical grade product typically may contain about 83% azadirachtin A and about 17% azadirachtin B. Furthermore, as used in this description and the claims, the abbreviation “PYR” is used to generically designate commercially available pyrethrins or commercially available pyrethroids, each of which contains a three membered ring system.

The PYR, which is a relatively stable compound, should be present in an amount to form a complex with the AZA A on opposite sides of the molecular structure thereof and sufficient to prevent decomposition of the azadirachtin A. In a preferred formulation, an aprotic solvent compatible with the AZA and PYR is provided that contains C₂-C₂₅ carbon atoms. The formulation may include, for example, an aprotic solvent such as a heterocyclic solvent containing C₂-C₂₀ carbon atoms and 1-10 oxygen atoms, or C₂-C₂₀ carbon atoms and 1-4 nitrogen atoms. Alternatively, the formulation may include an aprotic mono, di-, or polycyclic aromatic solvent having C₂-C₂₅ carbon atoms. The formulation is substantially free of water, i.e., containing no more than about 0.5% by weight and preferably no more than about 0.1% by weight of water. At least about 90% of the AZA A originally present remains after an accelerated aging test of 30 days at 40° C. in a sealed container. A non-ionic emulsifier may also be incorporated in the formulation that preferably has an HLB (hydrophilic-lypophilic balance) of about 1 to about 20.

The molar ratio of PYR to AZA A should be within the range of from about 0.5/1-10.5/1, may be from about 1.5/1-7/1, and preferably is within the range of 3/1-6/1.

The preferred PYR agents include pyrethroids such as bifenthrin and permethrin having two stereoisomers, fenpropathrin having four stereoisomers, a cypermethrin such as zeta cypermethrin having eight stereoisomers, or a natural pyrethrin. The solvent preferably is selected from the group consisting of tetrahydrofuran, dioxane, crown ethers, cyclohexanone, an alkylene carbonate such as propylene carbonate, napthalenes, blended napthalenes, toluenes, xylenes, anthracenes, and alkyl derivatives thereof. The non-ionic, substantially water-free emulsifier is preferably selected from the group consisting of polyethoxylated alcohols, alkyl phenol ethoxylates, linear and/or branched fatty acid ethoxylates, alkyl and aromatic based block or polyalkylene oxide copolymers, sorbitol oleates, hydrocarbon linear and/or branched alcohol ethoxylates, alkoxylated amides or amines, comb block polymers, ethylene/propylene block polymers, and alkylated glycerols.

The formulation of this invention is especially useful as a stable concentrate designed to be diluted with, for example, water by the user at the time of use. The emulsifier is present to assure formation of an emulsion when the formulation is diluted with water. Chemical stability of the AZA A portion of the technical grade AZA concentrate, in accordance with this invention, is characterized by a lack of hydrolysis and hence, no resulting chemical rearrangement of the AZA A chemical structure. Thus, the formulation exhibits shelf stability under conditions of varying ambient temperatures during transportation and storage, and has extended shelf storage longevity before sale. For example, temperatures during transportation can vary from well below freezing to 120-130° F. or more. Similarly, the temperature of the surroundings where the product is stored before and after sale, can vary dramatically. The time the product remains on the shelf before distribution is also widely divergent and unpredictable.

### BRIEF DESCRIPTION OF THE DRAWINGS

FIG. 1 is a graph of the percent of AZA A decomposition at varying mole ratios of bifenthrin to AZA A;

FIG. 2 is a graph of the percent of AZA A decomposition at varying mole ratios of permethrin to AZA A; and

FIG. 3 is a graph of the percent of AZA A decomposition at varying mole ratios of zeta cypermethrin to AZA A.

### DETAILED DESCRIPTION OF THE PREFERRED EMBODIMENT

PYR insecticides have been in use for many years to control a variety of insect species. PYRs, although exhibiting quick knock-down effects against insects, do not provide long lasting control because of instability of various agents. Use of this class of insecticides has continued because they comply with environmental standards and are effective, even if only for short intervals of time. In addition, the cost benefit ratio of PYRs is reasonable based on the selling price of the agents as compared with the insect control obtained by their use. PYRs prevent the sodium channels of insects from closing, causing constant nerve impulse transmission, tremors, and eventual death as the sodium is pumped to cause excitation of neurons.

AZAs, on the other hand, act as both a feeding deterrent and a growth regulator. These agents also are longer lasting than PYRs and function in a different manner. On a cost per mole basis, the current cost of AZAs is as much as 20-25 times greater than the purchase price for PYRs. In view of this cost differential, it is necessary that formulations not only be efficacious, but the AZA A content must not deteriorate significantly during on-shelf storage, or the interval of time between purchase of the formulation by a user, and actual application of the pesticide.

Although the AZA B fraction of AZA is relatively storage stable, AZA A, having the structural formula below, is inherently unstable.

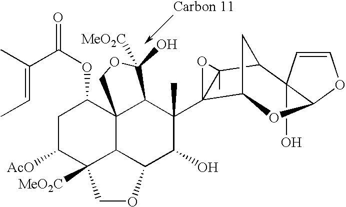

The structural formula of stable AZA B is as follows:

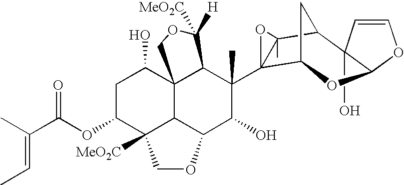

Two degradates of AZA A have been observed. Degradate 1 corresponds to the loss of oxygen from the AZA A parent. It is postulated that the major cause of instability in AZA A stems from the hemiacetyl configuration at carbon 11. The hydroxyl group at carbon 11 in the presence of water and acid can epimerize. Opening and closing of amphoteric carbon 11 can result in the following structural changes:

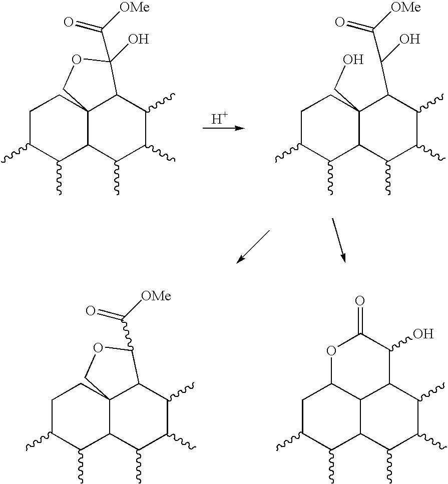

Thus, the resulting AZA A decomposition structures may be represented as:

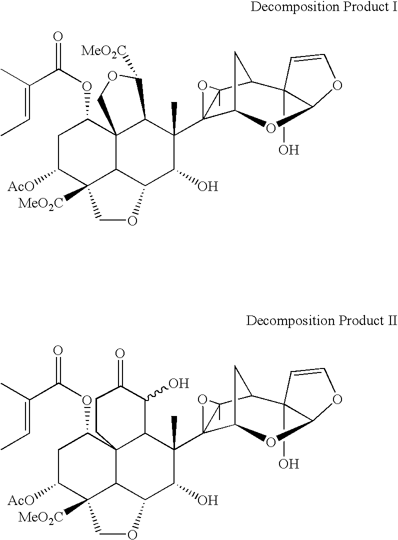

A number of different active ingredients have been combined with AZA in an effort to prevent or limit decomposition of the AZA A. Generally, the agents added have increased the decomposition of the AZA A rather than the desired prevention.

However, it has now been found that when a sufficient quantity of a three member cyclic ring PYR is added to AZA, the AZA A is stabilized and any resulting decomposition is minimized, with more than 90% of the AZA A originally present remaining, and generally no more than about a 5% loss, when the formulation is subjected to an accelerated aging test at 40° C. for 30 days in a sealed container.

It is believed that the combination of PYRs with AZA results in a chemical complexation with AZA A as contrasted with a chemical reaction of the two compounds. Because this PYR induced AZA A chemical stability has been observed with a number of PYRs having a three membered cyclopropane ring, it is believed that the three membered ring structure of these PYRS and the resulting side chains attached thereto creates a favorable interaction with the AZA A to prevent hydrolysis of the AZA A from occurring.

It is further postulated that the unique three membered cyclopropane ring system of the PYRS allows for a complexation of the PYR with the AZA A that is believed to force the functional groups to complex on at least one side of the cyclopropane ring to interact with the AZA A molecule preventing decomposition from taking place at the carbon 11 site. An exact degree of complexation has not been established, but it is further believed that the smaller PYR molecules are associated with the much larger molecular weight AZA A, thereby preventing opening of carbon 11 of the AZA A. By providing a greater molar weight percentage of the PYR relative to the molar percentage of AZA A, within the limits specified herein, there is a greater opportunity for the PYR to associate with the AZA A and thus forestall hydrolysis and decomposition of the AZA A.

The amount of PYR that is combined with AZA to enhance the stability of the AZA A is variable within certain limits. A storage stable, efficacious, substantially water-free pesticide formulation dilutable by the user is provided that contains a molar ratio of AZA A to PYR that is adequate to prevent hydrolysis of AZA A and consequent chemical rearrangement of AZA A resulting in decomposition of the AZA A during storage of the formulation for a period of at least about two years. A storage stable, efficacious pesticide formulation contains from about 3% to about 0.01% of AZA (A+B), based on the weight of the formulation, and from about 0.01% to about 10% by weight of a PYR, based on the weight of the formulation. Better results are obtained when about 1% to about 3% by weight of PYR, based on the weight of the formulation are provided, with best results being obtained when the amount of PYR is from about 1.5% to about 3% by weight, based on the weight of the formulation.

On a molar basis, good results are obtained when the molar ratio of PYR to AZA A is within the range of 0.5/1-10.5/1. Better results obtain when the molar ratio of PYR to AZA A is within the range of 1.5/1-7/1, with the best results being realized when the molar ratio of PYR to AZA A is about 3/1-6/1.

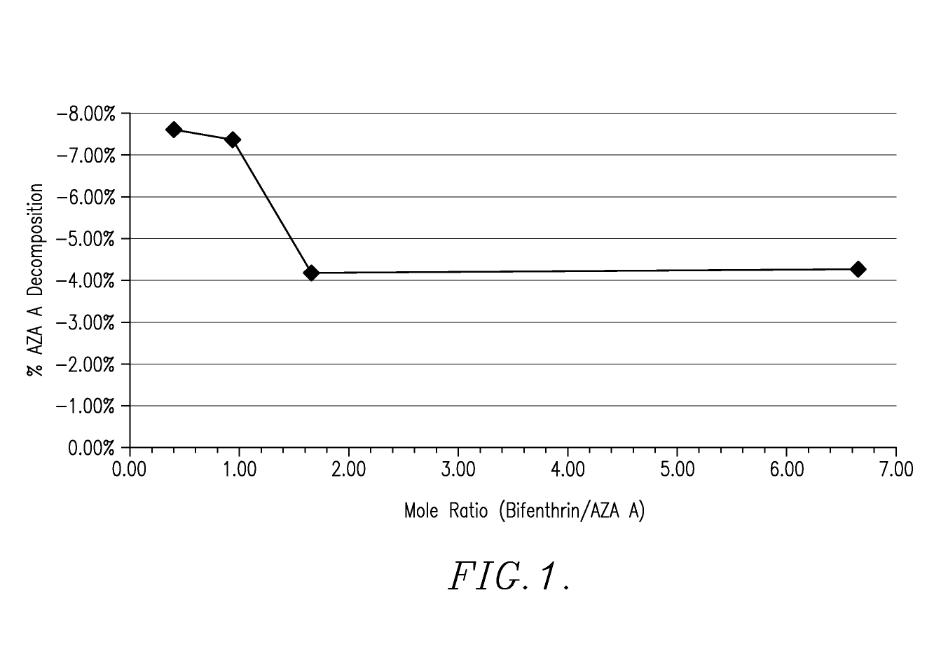

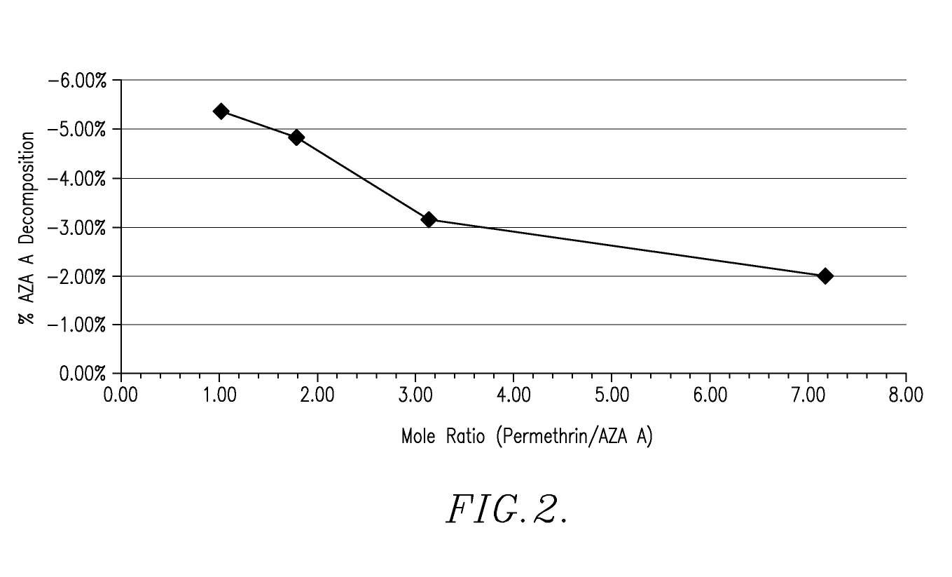

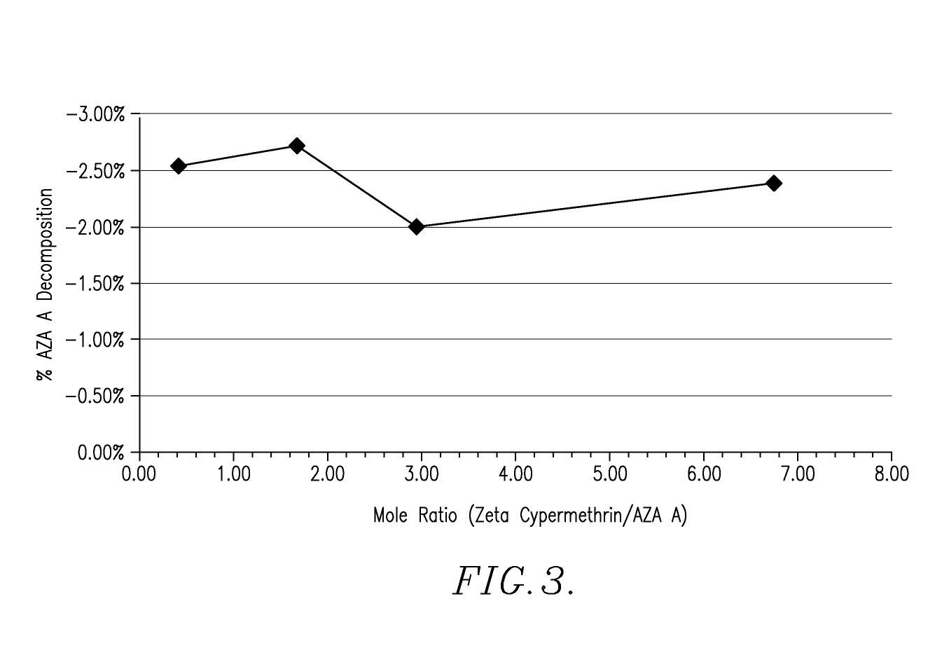

It has been unexpectedly discovered that employing a pyrethroid with greater than two isomers further enhances AZA A stability. This is evidenced by reviewing FIGS. 1, 2, & 3 which show that zeta cypermethrin, having eight stereoisomers, stabilizes the AZA A to a substantially greater degree than bifenthrin and permethrin, which each have two stereoisomers. Furthermore, zeta cypermethrin, as shown in FIG. 3, holds a lower, non-labile level of AZA A decomposition as compared to bifenthrin in FIG. 1 and permethrin in FIG. 2.

It is theorized that the additional stereoisomers of zeta cypermethrin allow for more efficient, multiple complexation probabilities of pyrethroid with AZA A and, thus, can maintain AZA A stability at a lower mole ratio than bifenthrin or permethrin. FIGS. 1-3, comparing the amount of decomposition of AZA A when bifenthrin, permethrin, and zeta cypermethrin, respectively, are used as the stabilization agent, show that the zeta cypermethrin (ZETA), having four times the stereoisomerization of bifenthrin (BIF) and permethrin (PER), is at least about four times as effective in stabilizing AZA A.

TABLE 1

| | Molar | Relative | Molar | Relative | Molar | Relative |
|---|---|---|---|---|---|---|
| ZETA | Ratio of | Stabili- | Ratio of | Stabili- | Ratio of | Stabili- |
| to | BIF and | zation | BIF and | zation | BIF and | zation |
| BIF and | PER to | of AZA A | PER to | of AZA A | PER to | of AZA A |
| PER | AZA A | Factor | AZA A | Factor | AZA A | Factor |
| ZETA | 1:1 | 11.4:1 | 2:1 | 5.9:1 | 7:1 | 7.5:1 |
| to | | | | | | |
| BIF | | | | | | |
| ZETA | 1:1 | 8.3:1 | 2:1 | 6.6:1 | 7:1 | 3.6:1 |
| to | | | | | | |
| PER | | | | | | |

PYRs have a three membered ring system characterized by a cyclopropane ring of which molecular groups R₁ and R₂ branch from two carbons of the central three carbon ring. Modifications of the molecular branches from the cyclopropane ring enhance insecticidal efficacy against various pests. PYRs that are useful in stabilizing AZA A include natural pyrethrins, allenthrin, bioresmethrin, resmethrin, bifenthrin, fenpropathrin, tetramethrin, sumithrin, permethrin, cyfluthrin, cypermethrin, zeta cypermethrin, tralomethrin, and deltamethrin.

Natural pyrethrins include:

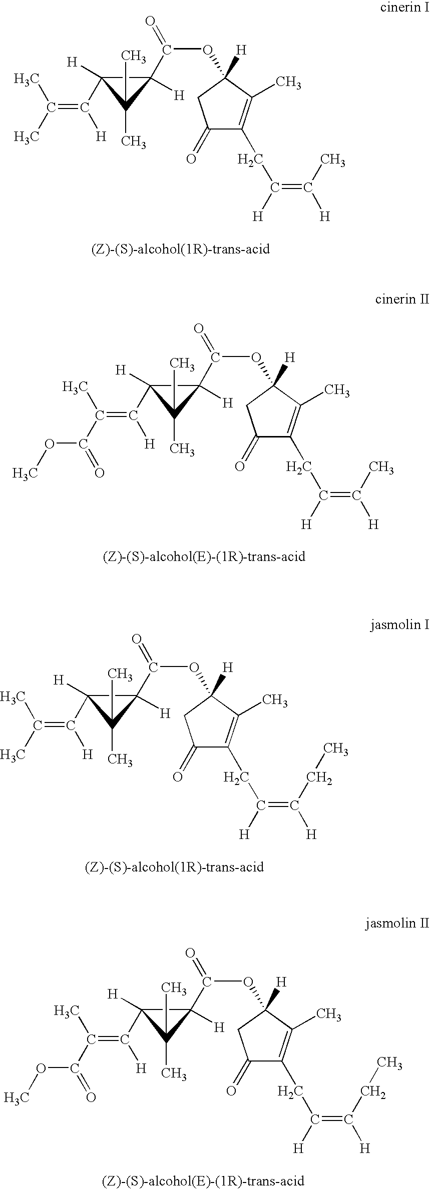

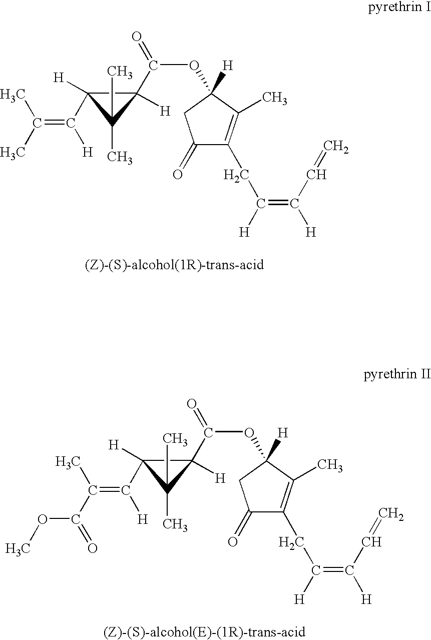

When a PYR was added to AZA A, the decomposition pathway of AZA A was stabilized, as shown by Table 2.

TABLE 2

| | | | | % Decomposition | Time Elapsed/ |
|---|---|---|---|---|---|
| Actives | AI %¹ | Solvent | Emulsifier | of AZA A and PYR | Condition |
| Azadirachtin A/B only | 3.01% | JeffSol AG-1555 | Triton X-100 | −12.64% | 1 Month/40° C. |
| Azadirachtin A/B | 2.00% | JeffSol AG-1555 | Triton X-100 | −7.61% | 1 Month/40° C. |
| Bifenthrin | 0.50% | | | −0.82% | |
| Azadirachtin A/B | 1.75% | JeffSol AG-1555 | Triton X-100 | −7.37% | 1 Month/40° C. |
| Bifenthrin | 1.00% | | | −2.21% | |
| Azadirachtin A/B | 1.50% | JeffSol AG-1555 | Triton X-100 | −4.20% | 1 Month/40° C. |
| | 1.50% | | | −2.96% | |
| | | | | −0.14% | 1 Month/Ambient |
| | | | | −2.82% | |
| Azadirachtin A/B | 0.50% | JeffSol AG-1555 | Triton X-100 | −4.30% | 1 Month/40° C. |
| Bifenthrin | 2.01% | | | −2.67% | |
| | | | | −1.03% | 1 Month/Ambient |
| | | | | −2.42% | |
| Bifenthrin only | 3.01% | JeffSol AG-1555 | Triton X-100 | −2.54% | 1 Month/40° C. |

¹AI = Active Ingredient

AZA alone experienced a loss of 12.64% of AZA A, whereas by increasing the ratio of PYR to AZA there was less loss of the active AZA A, confirming that the added PYR stabilized the AZA A.

FIG. 1 is a plot of the percent AZA A decomposition on the Y-axis, as compared with the mole ratio of bifenthrin/AZA A on the X-axis, under an accelerated aging test of 30 days at 40° C. The loss of AZA A decreased as the mole ratio of PYR to AZA A approached 2:1, where the PYR was present in an amount to form a complex with the AZA A on opposite sides of the molecular structure thereof and sufficient to prevent further decomposition of the AZA A.

FIG. 2 compares the percent of AZA A decomposition on the Y-axis with the mole ratio of permethrin to AZA A on the X-axis, again under an accelerated aging test of 30 days at 40° C. demonstrating that as the mole ratio of AZA A increased, there was a decrease in the loss of AZA A.

FIG. 3 compares the percent of AZA A decomposition on the Y-axis with the mole ratio of zeta cypermethrin to AZA A on the X-axis, also under an accelerated aging test of 30 days at 40° C. The most effective ratio was 1:1 zeta cypermethrin to AZA A, showing a loss of only 1%.

FIGS. 1-3 setting forth the results of accelerated tests where AZA is combined with a PYR, confirm that the decomposition of AZA A is substantially less where the molar ratio of PYR to AZA A is of the order of 1:1 through 7:1, as compared with the loss of more than 12% AZA A alone without incorporation of a PYR, as set forth in Table 2.

The preferred solvent, JeffSol AG-1555, is a propylene carbonate having a molecular formula of C₄H₆O₃:

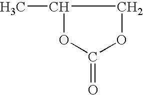

The amount of non-ionizing aprotic solvent present is preferably in the range of from about 70% to about 90% by weight, based on the weight of the formulation. Other aprotic solvents may be used, including heterocyclic and aromatic solvents, compatible with the AZA and the PYR and containing C₂-C₂₅ carbon atoms. At least one branch from the heterocyclic system may include hydroxyls, carboxylics, amines, amides, ketones, and lactones. Usable heterocyclic solvents include cyclopentane, cyclopentanone, cycloheptanone, NMP (N-methylpyrolidone), alkyl derivatives thereof, non-ionic polyethoxylated alcohols, and non-ionic sorbitan derivatives including sorbitan monopalmitates, monolaurates, monostearates, monooleates, and tristearates. Usable blended aromatic solvents include Exxon Aromatic 100 napthalenes, Aromatic 150 napthalenes, Aromatic 200 napthalenes, napthalene depleted Aromatic 200, toluene, xylenes, anthracenes, and alkyl derivatives thereof.

A substantially water-free non-ionic emulsifier having an HLB of from about 1 to about 20 is desirably incorporated in the formulation, preferably at a level of from about 0 to 20% by weight of the formulation, to assure formation of a stable, clear emulsion when the formulation is diluted with water by the end user. The emulsifier should contain no more than about 0.5% water, and preferably less than 0.1% water. Triton X-100 having the molecular formula C₁₄H₂₂O(C₂H₄O)n corresponding to the following structural formula, is a preferred emulsifier:

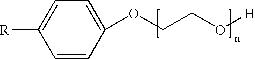

where n=9.5, and R can be H or linear or branched alkyl groups. Other Triton non-ionic emulsifiers can be used where n=2-30. Other exemplary emulsifiers include polyethoxylated alcohols, alkyl phenol ethoxylates, linear and/or branched fatty acid ethoxylates, alkyl and aromatic based block or polyalkylene oxide copolymers, sorbitol oleates, hydrocarbon linear and/or branched alcohol ethoxylates, alkoxylated amides or amines, comb block polymers, ethylene/propylene block polymers, and alkylated glycerols.

Incorporation of a solvent and an emulsifier of the classes described produces a clear, as opposed to a milky, emulsion which remains clear when added to water for application.

Preferred formulations include:

TABLE 3
ACTIVE INGREDIENTS

| Active Name | % AI¹ w/w | Active Content/Gallon |
|---|---|---|
| Zeta-Cypermethrin | 3.3% | 0.33 |
| Azadirachtin A/B | 1.62% | 0.167 |

¹AI = Active Ingredient

TABLE 4
ALL INGREDIENTS

| Ingredient | % Weight | Function | Mass (g) |
|---|---|---|---|
| JeffSol AG- = 1555 | 79.65% | Solvent | 250.1 |
| Zeta-Cypermethrin (95.9%) | 3.47% | Active | 10.90 |
| Triton X-100 | 13.79% | Emulsifier | 43.3 |
| Technical Azadirachtin (52.5% | 3.09% | Active | 9.7 |
| AZA A/B) | | | |

TABLE 5
ACTIVE INGREDIENTS

| Active Name | AI %¹ | Active Content/Gallon |
|---|---|---|
| Bifenthrin | 3.30% | 0.33 |
| Azadirachtin A/B | 1.62% | 0.162 |

¹AI = Active Ingredient

TABLE 6
ALL INGREDIENTS

| Ingredient | % Weight | Function | Mass (g) |
|---|---|---|---|
| JeffSol AG- = 1555 | 79.69% | Solvent | 250.23 |
| Bifenthrin (96.2%) | 3.43% | Active | 10.8 |
| Triton X-100 | 13.79% | Emulsifier | 43.3 |
| Technical Azadirachtin (52.5% | 3.09% | Active | 9.7 |
| AZA A/B) | | | |

TABLE 7
ACTIVE INGREDIENTS

| Active Name | AI %¹ | Active Content/Gallon |
|---|---|---|
| Permethrin | 3.2% | 0.32 |
| Azadirachtin A/B | 1.62% | 0.162 |

¹AI = Active Ingredient

TABLE 8
ALL INGREDIENTS

| Ingredient | % Weight | Function | Mass (g) |
|---|---|---|---|
| JeffSol AG- = 1555 | 79.72% | Solvent | 250.3 |
| Permethrin (94.0%) | 3.40% | Active | 10.7 |
| Triton X-100 | 13.79% | Emulsifier | 43.3 |
| Technical Azadirachtin (52.5% | 3.09% | Active | 9.7 |
| AZA A/B) | | | |

AZA plus PYRs have been studied in conventional oil systems, such as soybean oil, canola oil, methylated soybean oil, epoxidized soybean oil, rape seed oil, and olive oil, all of which contained an emulsifier having as much as 5% of water. None of these oils in combination with the PYR stabilized the AZA A in the formulation, largely because of the presence of moisture in the emulsifier. When AZA is combined with PYR and the types of solvents and emulsifiers disclosed herein, the AZA A of the formulation is stabilized. Table 9 records test results of AZA+soybean oil as compared with AZA+PYR+soybean oil. The addition of seed oil to the AZA+PYR did not stabilize the AZA A.

TABLE 9
AZADIRACHTIN STABILITY TESTS

| | | | | | AZA A |
|---|---|---|---|---|---|
| | | | | | Stability |
| | | Seed Oil | Test | Elapsed | in Formu- |
| Actives | AI %¹ | Carrier² | Condition | Time | lation |
| AZA A/B | 3.00% | Soybean Oil | 40° C. | 32 Days | −27.02% |
| AZA A/B | 0.50% | Soybean Oil | 40° C. | 32 Days | −54.27% |
| Bifenthrin | 2.00% | | | | |
| AZA A/B | 0.50% | Soybean Oil | 40° C. | 32 Days | −52.62% |
| Permethrin | 2.00% | | | | |
| AZA A/B | 0.50% | Soybean Oil | 40° C. | 32 Days | −48.25% |
| Z- | 2.00% | | | | |
| Cypermethrin | | | | | |

¹AI = Active Ingredient
²50% Seed Oil/50% Tween 85 Emulsifier containing 5% water

Efficacy of the stable AZA-PYR formulations of this invention, including a solvent and an emulsifier of the types described, have been demonstrated by greenhouse tests on live potato aphids.

TABLE 10
LIVE POTATO APHIDS ON TOMATOES

| Treatment | 0 DAT₁ | 3 DAT₁ | 7 DAT₁ | 0 DAT₂ | 3 DAT₂ | 7 DAT₂ |
|---|---|---|---|---|---|---|
| Azadirachtin @ 0.0008 lbs/gal | 338 a | 120 b | 18 c | 11 c | 3 c | 1 c |
| 0.00055 lbs Azadirachtin/gal + 0.005 lbs | 366 a | 19 c | 13 c | 18 c | 2 c | 0 c |
| Bifenthrin/gal | | | | | | |
| 0.005 lbs bifenthrin/gal | 357 a | 131 b | 179 b | 162 b | 89 b | 64 b |
| Untreated Control | 381 a¹ | 470 a | 547 a | 482 a | 511 a | 433 a |

¹Aphid mean numbers followed by the same letter are not statistically different at the 5% level.

Phytotoxicity studies of the AZA+PYR+solvent+emulsifier established that the formulations of this invention are not phytotoxic to plants as shown in Table 11.

TABLE 11

| | Tomato Leaf | | | | |
|---|---|---|---|---|---|
| | Phytotoxicity Ratings | | | | |
| | (1.0 = no | | | | |
| Treatment | phyto - 9.0 = dead) | | | | |
| 0.3% Azadirachtin @ 60 ppm (Sufactant “A”) | 1.0 | 1.0 | 1.0 | 1.0 | 1.0 |
| 0.3% Azadirachtin @ 120 ppm (Surfactant “A”) | 1.0 | 1.0 | 1.3 | 1.3 | 1.0 |
| 0.3% Aza + 3% Bifenthrin applied | 1.0 | 1.0 | 1.0 | 1.0 | 1.0 |
| @ 60 ppm Aza (Surf “B”) | | | | | |
| 0.3% Aza + 3% Bifenthrin applied | 1.0 | 1.0 | 1.0 | 1.0 | 1.0 |
| @ 120 ppm Aza (Surf “B”) | | | | | |
| 0.3% Azadirachtin @ 60 ppm (Sufactant “B”) | 1.0 | 1.0 | 1.3 | 1.3 | 1.0 |
| 0.3% Azadirachtin @ 120 ppm (Sufactant “B”) | 1.0 | 1.3 | 1.3 | 1.3 | 1.0 |
| Untreated Control | 1.0 | 1.0 | 1.0 | 1.0 | 1.0 |

We claim:

1. A storage stable, efficacious pesticide formulation comprising from about 3% to about 0.01% by weight of AZA (AZA A+AZA B) based on the weight of the pesticide formulation, from about 0.01% to about 10% by weight of a PYR based on the weight of the formulation, and from about 70% to about 90% by weight based on the weight of the formulation, of a non-ionizing aprotic solvent compatible with the AZA and the PYR and selected from the group of heterocyclic and mono, di-, and polycyclic aromatic solvents, each having C₂-C₂₅ carbon atoms, and wherein the formulation contains no more than about 0.5% water and at least about 90% of the AZA A originally present remains after an accelerated aging test of 30 days at 40° C. in a sealed container.

2. A pesticide formulation as set forth in claim 1, wherein is provided from about 1% to about 3% by weight based on the weight of the formulation of a PYR.

3. A pesticide formulation as set forth in claim 1, wherein is provided from about 1.5% to about 3% by weight based on the weight of the formulation of a PYR.

4. A storage stable, efficacious pesticide formulation comprising a quantity of AZA and an amount of a PYR, the molar ratio of PYR to AZA A being within the range of from about 0.5/1-10.5/1, and wherein the formulation contains no more than about 0.5% water and at least about 90% of the AZA A originally present remains after an accelerated aging test of 30 days at 40° C. in a sealed container.

5. A pesticide formulation as set forth in claim 4, wherein the molar ratio of PYR to AZA A is within the range of 1.5/1-7/1.

6. A pesticide formulation as set forth in claim 4, wherein the molar ratio of PYR to AZA A is within the range of 3/1-6/1.

7. A storage stable, efficacious, water-free pesticide formulation dilutable by the user comprising AZA and a PYR, the molar ratio of PYR to AZA A being adequate to prevent hydrolysis and consequent chemical rearrangement of AZA A resulting in decomposition of the AZA A during storage of the formulation for a period of about two years.

8. A pesticide formulation as set forth in claim 7, wherein the PYR is present in an amount to form a complex with the AZA A on opposite sides of the molecular structure thereof and sufficient to prevent hydrolysis and decomposition of the AZA A.

9. A pesticide formulation as set forth in claim 4, wherein said PYR is bifenthrin.

10. A pesticide formulation as set forth in claim 4, wherein said PYR is permethrin.

11. A pesticide formulation as set forth in claim 4, wherein said PYR is zeta-cypermethrin.

12. A pesticide formulation as set forth in claim 4, wherein said PYR is fenpropathrin.

13. A pesticide formulation as set forth in claim 4, wherein said PYR is a natural pyrethrin.

14. A pesticide formulation as set forth in claim 1, wherein the heterocyclic aprotic solvent contains C₂-C₂₀ carbon atoms and 1-10 oxygen atoms.

15. A pesticide formulation as set forth in claim 14, wherein the heterocyclic solvent is an alkylene carbonate.

16. A pesticide formulation as set forth in claim 15, wherein the alkylene carbonate is propylene carbonate.

17. A pesticide formulation as set forth in claim 1, wherein the heterocyclic solvent has at least one branch selected from the group consisting of hydroxyls, carboxylics, amines, amides, ketones, and lactones.

18. A pesticide formulation as set forth in claim 14, wherein the heterocyclic solvent is selected from the group consisting of tetrahydrofuran, dioxane, crown ethers, cyclohexanone, cyclohexanol cyclopentane, cyclopentanone, cycloheptanone, NMP (N-methylpyrolidone), alkyl derivatives thereof, non-ionic polyethoxylated alcohols, sorbitan monopalmitates, sorbitan monolaurates, sorbitan monostearates, sorbitan monooleates, sorbitan tristearates, napthalenes, toluenes, xylenes, anthracenes, and alkyl derivatives thereof.

19. A storage stable, efficacious pesticide formulation comprising from about 0.05% to about 3% by weight of AZA based on the weight of the pesticide formulation, from about 0.01% to about 10% by weight of PYR based on the weight of the formulation, from about 70% to about 90% by weight, based on the weight of the formulation, of a non-ionizing heterocyclic aprotic solvent compatible with the AZA and the PYR and containing C₂-C₂₀ carbon atoms and 1-10 oxygen atoms, from about 0 to 15% by weight based on the weight of the formulation, of a nonionic emulsifier having an HLB of from about 1 to about 20, and wherein the formulation contains no more than about 0.5% water and at least about 90% of the AZA A originally present remains after an accelerated aging test of 30 days at 40° C. in a sealed container.

20. A pesticide formulation as set forth in claim 1, wherein the aprotic aromatic solvent is selected from the group consisting of napthalene-depleted aromatic blends, napthalene blends, toluenes, xylenes, and alkyl derivatives thereof.

21. A pesticide formulation as set forth in claim 1, wherein is included a non-ionic emulsifier having an HLB of from about 1 to about 20.

22. A pesticide formulation as set forth in claim 21, wherein the emulsifier is selected from the group consisting of polyethoxylated alcohols, alkyl phenol ethoxylates, linear and/or branched fatty acid ethoxylates, alkyl and aromatic based block or polyalkylene oxide copolymers, sorbitol oleates, hydrocarbon linear and/or branched alcohol ethoxylates, alkoxylated amides or amines, comb block polymers, ethylene/propylene block polymers, and alkylated glycerols.

23. A pesticide formulation as set forth in claim 21, wherein the emulsifier has the molecular formula C₁₄H₂₂O(C₂H₄O)n wherein n is about 9.5.

24. A pesticide formulation as set forth in claim 21, wherein the emulsifier has the structural formula: 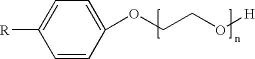
where n is 2-30 and R is H or C₂-C₂₀ linear or branched alkyl groups.

25. A storage stable, efficacious pesticide formulation containing AZA A and a pyrethroid having at least four stereoisomers.

26. A pesticide formulation as set forth in claim 25, wherein the pyrethroid has at least eight stereoisomers.

27. A pesticide formulation as set forth in claim 26, wherein the pyrethroid is zeta cypermethrin.
